(19) United States
(12) Patent Application Publication
(10) Pub. No.: US 2017/0257883 A1
(43) Pub. Date: Sep. 7, 2017

(54) COMMUNICATION SYSTEM, BASE STATION, USER EQUIPMENT, COMMUNICATION METHOD, AND RECORDING MEDIUM

(71) Applicant: NEC Corporation, Minato-ku, Tokyo (JP)

(72) Inventor: Hideki BESSHO, Tokyo (JP)

(73) Assignee: NEC Corporation, Minato-ku, Tokyo (JP)

(21) Appl. No.: 15/506,006

(22) PCT Filed: Sep. 1, 2015
(86) PCT No.: PCT/JP2015/004434

§ 371 Date: Feb. 23, 2017

(30) Foreign Application Priority Data
Sep. 3, 2014 (JP) 2014-179456

(51) Int. Cl. H04W 72/14; H04L 1/18

(52) U.S. Cl. CPC H04W 72/14; H04L 1/1874; H04W 28/14

(57) ABSTRACT

A communication system, which is preventing recognition inconsistency with respect to a buffer size of user equipment between the user equipment and a base station, includes the user equipment and a base station. The user equipment buffers uplink data. The user equipment transmits, in an uplink, a buffer status report for identifying an amount of the uplink data buffered. The base station transmits, in a downlink, grant information for allocating a radio resource to the user equipment. The user equipment transmits, based on the amount of the buffered uplink data, the buffer status report for stopping of transmission of the grant information by the base station. The base station receives the buffer status report and stops the transmission of the grant information, based on the received buffer status report.

### TECHNICAL FIELD

The present disclosure relates to a communication system, a base station, user equipment, a communication method, and a recording medium.

### BACKGROUND ART

The 3rd generation (3G) mobile telecommunication system standardization project (3GPP: Third Generation Partnership Project) has been conducting a study on Long Term Evolution (LTE) and LTE-Advanced.

PTL 1 discloses a method of controlling a transmission period of a radio resource allocation request from a terminal to a base station in LTE. The terminal issues a Scheduling Request (SR) as a radio resource allocation request message for the base station in order to request for allocation of a radio resource. In PTL 1, a transmission period of the SR is controlled in accordance with a retention amount in a transmission buffer of the terminal in order to suppress radio resource allocation for transmitting the SR. The SR is transmitted to the base station (eNode B) in order to request for allocation of an uplink radio resource when the terminal holds transmission data to be transmitted to the base station. When receiving the SR from the terminal, the base station determines a radio resource to be allocated to the terminal in accordance with an availability status of the uplink radio resource at a point in time of receiving the SR. In addition, the base station transmits a radio resource allocation notice message (SG: Scheduling Grant) to the terminal in order to notify the allocated radio resource. Upon receiving the SG from the base station, the terminal transmits data to the base station by using the radio resource notified by the SG.

### CITATION LIST

### Patent Literature

### PTL 1: Japanese Unexamined Patent Application Publication No. 2010-114681

### SUMMARY OF INVENTION

### Technical Problem

However, PTL 1 does not disclose a specific method for estimating an actual buffer retention amount from a buffer retention amount that the base station receives from the terminal. In addition, PTL 1 does not disclose a relation between an estimated buffer retention amount and a radio resource allocation notice message (SG).

Regarding the above, the inventor has found a possibility (problem) that a situation may arise in which an actual buffer size of the terminal is different from a buffer size estimated by the base station.

Further, the inventor has found another possibility (problem). There is a possibility (problem) that a situation may arise in which inconsistent recognition with respect to a buffer size of a buffer of user equipment (terminal) between the user equipment and the base station causes retention of transmission of uplink data of the user equipment, and appropriate scheduling of a radio resource may not be performed.

In view of the above, one object of exemplary embodiments is to provide a communication system, a base station, user equipment, a communication method, and a recording medium capable of preventing recognition inconsistency with respect to a buffer size of user equipment between the user equipment and a base station. It should be noted that the above object be merely one of a plurality of objects that each of the exemplary embodiments disclosed herein attempts to accomplish. Other objects or problems and novel features will become apparent from the description or the accompanying drawings.

### Solution to Problem

A communication system according to an exemplary embodiment includes user equipment and a base station. The user equipment is configured to buffer uplink data, and is configured to transmit, in an uplink, a buffer status report for identifying an amount of the buffered uplink data. The base station is configured to transmit, in a downlink, grant information for allocating a radio resource to the user equipment. The user equipment transmits, based on the amount of the buffered uplink data, the buffer status report for stopping transmission of the grant information by the base station. The base station receives the buffer status report and stops transmission of the grant information, based on the buffer status report.

In addition, a base station according to an exemplary embodiment is configured to communicate with user equipment. The base station includes a receiver configured to receive, in an uplink, a buffer status report for identifying an amount of uplink data buffered by the user equipment. In addition, the base station includes a transmitter configured to transmit, in a downlink, grant information for allocating a radio resource for the uplink data. In addition, the base station includes a processor configured to control the transmitter so as to stop transmission of the grant information when the buffer status report indicates stopping of transmission of the grant information by the base station.

In addition, user equipment according to an exemplary embodiment includes a buffer configured to buffer uplink data. In addition, the user equipment includes a transmitter configured to transmit, in an uplink, a buffer status report for identifying an amount of the uplink data buffered in the buffer. In addition, the user equipment includes a receiver configured to receive, in a downlink, grant information for allocating a radio resource to the user equipment. In addition, the user equipment includes a processor configured to control the transmitter, based on the amount of the uplink data buffered in the buffer, in a way such that information indicating stopping of transmission of the grant information is included.

In addition, a communication method of a base station according to an exemplary embodiment includes receiving, in an uplink, a buffer status report for identifying an amount of uplink data buffered by user equipment, transmitting, in a downlink, grant information for allocating a radio resource for the uplink data, and stopping transmission of the grant information when the buffer status report indicates stopping of transmission of the grant information by the base station.

In addition, a recording medium according to an exemplary embodiment stores a program for causing a computer to execute a communication method of a base station. The program causes the computer to execute receiving, in an uplink, a buffer status report for identifying an amount of uplink data buffered by user equipment, transmitting, in a downlink, grant information for allocating a radio resource for the uplink data, and stopping transmission of the grant information when the buffer status report indicates stopping of transmission of the grant information by the base station.

### Advantageous Effects of Invention

The exemplary embodiments of the present invention make it possible to prevent recognition inconsistency with respect to a buffer size of user equipment between the user equipment and a base station.

### BRIEF DESCRIPTION OF DRAWINGS

FIG. 1 is a diagram illustrating a communication system according to a first exemplary embodiment;

FIG. 2 is a diagram illustrating user equipment according to the first exemplary embodiment;

FIG. 3 is a diagram illustrating a base station according to the first exemplary embodiment;

FIG. 4 is a diagram illustrating a communication system according to a second exemplary embodiment;

FIG. 5 is a sequence chart illustrating an operation according to the second exemplary embodiment;

FIG. 6 is a diagram illustrating an example of an operation according to the second exemplary embodiment; and

FIG. 7 is a diagram illustrating another example of an operation according to the second exemplary embodiment.

### DESCRIPTION OF EMBODIMENTS

Exemplary embodiments are specifically described below in detail with reference to the drawings. In each of the drawings, the same or corresponding components are assigned with the same reference numerals, and description therefor will not be repeated as needed for clarification of illustration.

A plurality of exemplary embodiments described below can be carried out independently from one another and in combination as appropriate. The plurality of exemplary embodiments have mutually different novel features. Accordingly, the plurality of exemplary embodiments contribute to solving mutually different objects or problems and contribute to exhibiting mutually different advantageous effects.

### First Exemplary Embodiment

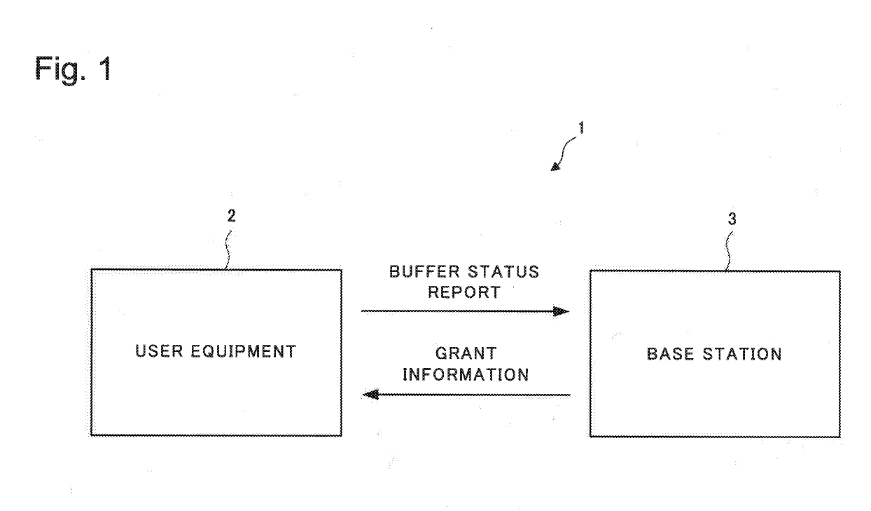

FIG. 1 illustrates a communication system according to a first exemplary embodiment.

In FIG. 1, a communication system 1 includes user equipment 2 and a base station 3. The user equipment 2 is configured to buffer uplink data. In addition, the user equipment 2 is configured to transmit, in an uplink, a buffer status report for identifying an amount of the buffered uplink data. In addition, the base station 3 is configured to transmit, in a downlink, grant information for allocating a radio resource to the user equipment 2. Herein, the user equipment 2 transmits, based on the amount of the uplink data being buffered, the buffer status report indicating a stop of the transmission of the grant information by the base station 3. Note that each of directions of arrows in the drawing indicates an example and is not intended to limit a direction of a signal between blocks.

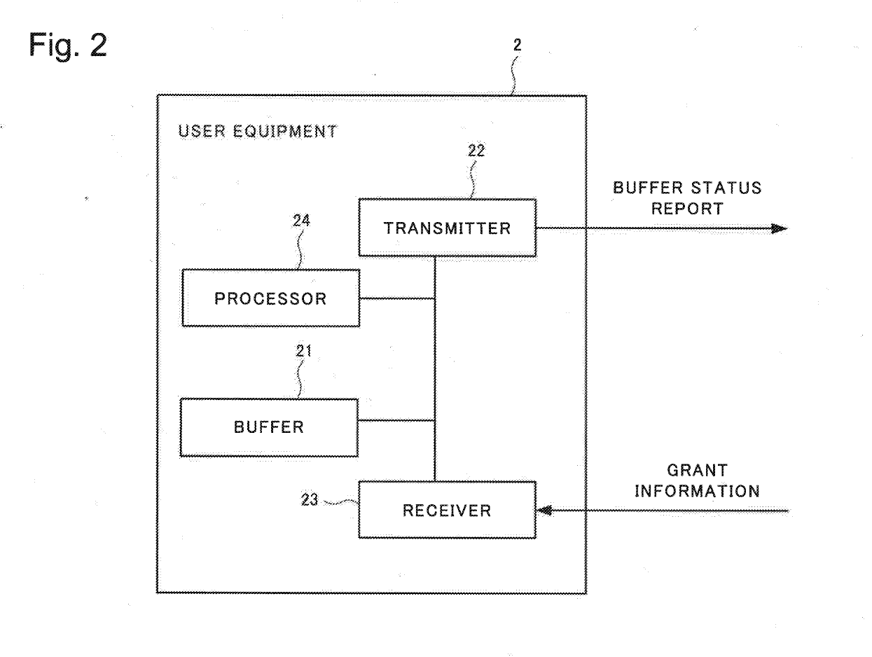

FIG. 2 illustrates user equipment according to the first exemplary embodiment.

In FIG. 2, the user equipment 2 includes a buffer 21, a transmitter 22, a receiver 23, and a processor 24. The buffer 21 is configured to buffer uplink data. The transmitter 22 is configured to transmit, in an uplink, a buffer status report for identifying an amount of the uplink data being buffered in the buffer. In addition, the receiver 23 is configured to receive, in a downlink, grant information for allocating a radio resource to the user equipment 2. The processor 24 is configured to control the transmitter 22 based on the amount of the uplink data being buffered in the buffer 21 in such a way that the buffer status report includes information indicating a stop of the transmission of the grant information by the base station. Note that the transmitter 22 and the receiver 23 may integrally operate as a transceiver or a transceiver circuit. Note that each of directions of arrows in the drawing indicates an example and is not intended to limit a direction of a signal between blocks.

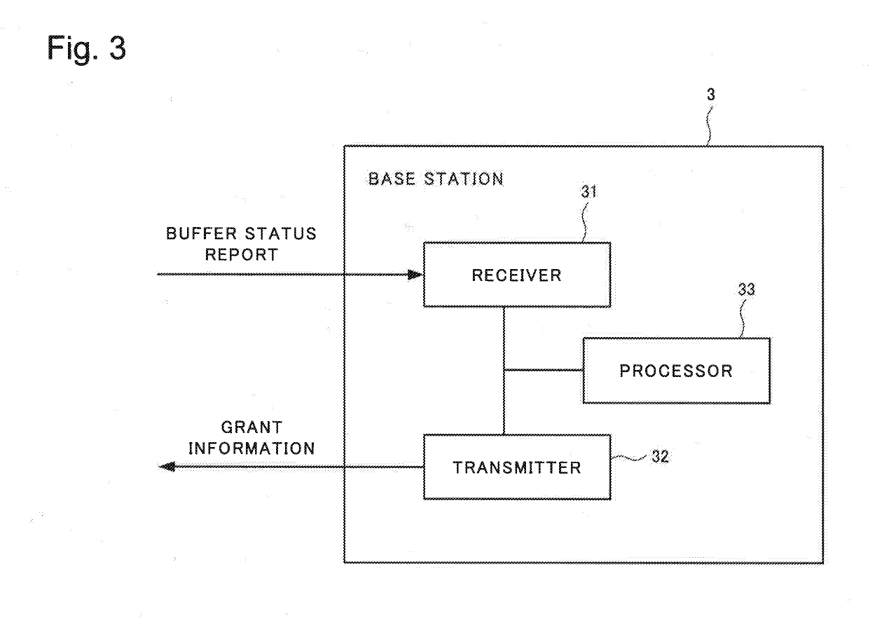

FIG. 3 illustrates a base station according to the first exemplary embodiment.

In FIG. 3, the base station 3 includes a receiver 31, a transmitter 32, and a processor 33.

The receiver 31 is configured to receive, in an uplink, a buffer status report for identifying an amount of uplink data buffered by the user equipment 2. The transmitter 32 is configured to transmit, in a downlink, grant information for allocating a radio resource for the uplink data. The processor 33 is configured to control the transmitter 32 so as to stop the transmission of the grant information when the buffer status report indicates a stop of the transmission of the grant information by the base station 3. Note that the receiver 31 and the transmitter 32 may integrally operate as a transceiver or a transceiver circuit.

The present exemplary embodiment is capable of preventing occurrence of recognition inconsistency with respect to an amount of uplink data of the user equipment 2 between the user equipment 2 and the base station 3. Thus, by preventing occurrence of recognition inconsistency, retention of the uplink data in the buffer of the user equipment 2 is suppressed. Consistent (optimized) recognition between the user equipment 2 and the base station 3 at higher precision allows the base station to perform radio resource allocation by use of grant information in an optimized manner.

For example, according to the present exemplary embodiment, the processor 33 controls the transmitter 32 so as to stop the transmission of the grant information when the buffer status report indicates a stop of the transmission of the grant information by the base station. Thus, it is possible to prevent occurrence of recognition inconsistency with respect to an amount of uplink data of the user equipment 2 between the user equipment 2 and the base station 3.

Note that each of directions of arrows in the drawing indicates an example and is not intended to limit a direction of a signal between blocks.

### Second Exemplary Embodiment

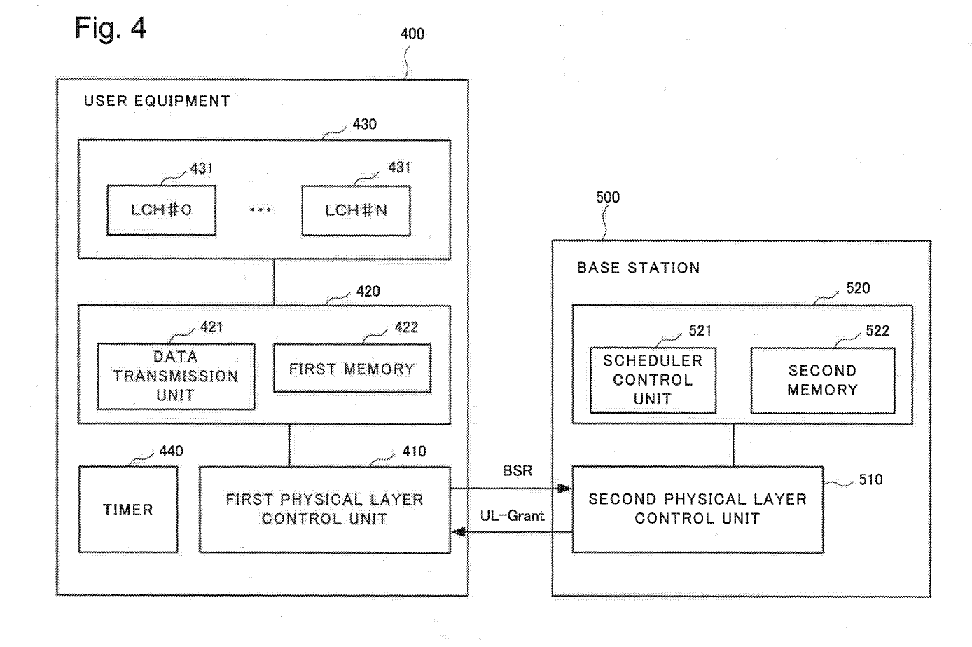

FIG. 4 illustrates a communication system according to a second exemplary embodiment.

In FIG. 4, the communication system includes user equipment 400 and a base station 500.

The user equipment 400 is user equipment (UE) for LTE. The base station 500 is a base station (evolved Node B (eNB or eNodeB)) for LTE. Note that each of directions of arrows in the drawing indicates an example and is not intended to limit a direction of a signal between blocks.

The user equipment 400 includes a first physical layer control unit 410, a Medium Access Control (referred to as MAC) layer unit 420, and a buffer 430.

The buffer 430 includes one or more logical channels 431. The buffer 430 buffers (also referred to as stores or saves), in each of the logical channels 431, data that can be transmitted in a Packet Data Convergence Protocol (referred to as PDCP) layer or in a Radio Link Control (referred to as RLC) layer. In the example in FIG. 4, data that can be transmitted is buffered in each of the 0th to Nth logical channels 431.

The MAC layer unit 420 includes a data transmission unit 421 and a first memory 422. The MAC layer unit 420 is configured to calculate a buffer size of data buffered in the buffer 430. The buffer size may be indicated for each one of the logical channels. In addition, the buffer size may be indicated on a Logical Channel Group (LCG) basis, which is a group of a plurality of logical channels. A LCG is a group of logical channels (LCHs) composed of a plurality of mapped LCHs. In addition, the LCG may be used as a unit for generating a buffer status report (BSR) by the MAC layer unit 420.

In addition, the first memory 422 of the MAC layer unit 420 stores (saves) the calculated buffer size (also referred to as buffer amount).

In addition, the MAC layer unit 420 generates, based on the buffer size stored in the first memory 422, a Buffer Status Report (BSR) as a buffer status report. For example, the BSR may include an identifier for identifying a logical channel group and a buffer size buffered in the logical channel group. The buffer size may indicate an actual data size (or buffer size), and may be indicated by an index value indicating presence of an actual data size (data size) in a predetermined range from a first buffer size to a second buffer size.

In addition, the data transmission unit 421 of the MAC layer unit 420 transmits the generated BSR to an uplink. In addition, the data transmission unit 421 transmits uplink data by using a resource to be allocated based on grant information from the base station 500.

The MAC layer unit 420 generates uplink data (UL Data) for transmission in a MAC layer.

The MAC layer unit 420 exchanges (also referred to as inputs and outputs, or transmits and receives) information with the first physical layer control unit 410.

The first physical layer control unit 410 transmits and receives information with a second physical layer control unit 510 of the base station 500. In addition, the first physical layer control unit 410 exchange information with the MAC layer unit 420.

Note that the user equipment 400 may include a timer 440, as illustrated in FIG. 4.

The base station 500 includes the second physical layer control unit 510 and a MAC layer 520. The MAC layer unit 520 includes a scheduler control unit 521 and a second memory 522.

The base station 500 receives the BSR transmitted by the user equipment 400.

The MAC layer unit 520 receives the BSR via the second physical layer control unit 510.

The scheduler control unit 521 estimates, based on the received BSR, a buffer size buffered in the buffer 430 of the user equipment 400.

The scheduler control unit 521 transmits, based on the estimated buffer size, uplink grant information (UL-Grant: Uplink-Grant) as grant information corresponding to the estimated buffer size to the user equipment 400. The UL-Grant is resource allocation information. Note that the scheduler control unit 521 can be simply referred to as a scheduler.

The second memory 522 stores (saves) therein the estimated buffer size of the buffer 430 of the user equipment 400.

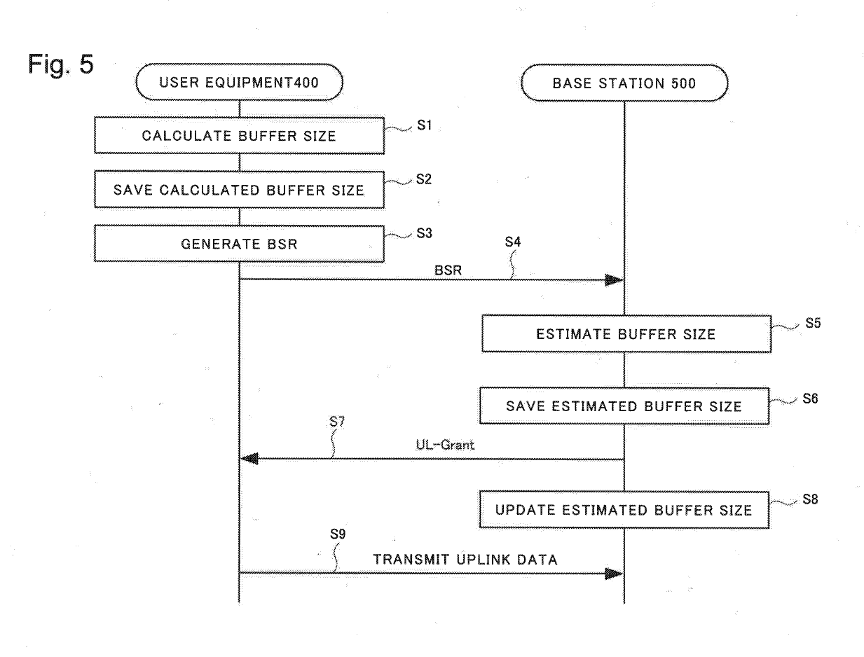

FIG. 5 is a sequence chart illustrating an operation according to the second exemplary embodiment.

At Si, the user equipment 400 calculates a buffer retention amount (buffer size) of each logical channel group (LCG), from a buffer amount of data retaining in each of the logical channels (LCHs) of the buffer 430 in a PDCP or RLC layer.

At S2, the user equipment 400 saves the calculated buffer amount (calculated buffer size) in the first memory 422.

At S3, the user equipment 400 generates a BSR from the buffer size saved in the first memory 422. For example, the user equipment 400 computes an index value of a BSR that is obtained from the saved buffer size and generates the index value as the BSR.

At S4, the user equipment 400 transmits the BSR to the base station 500.

At S5, the base station 500 estimates an uplink buffer size (UL buffer size) of the user equipment 400 based on the received BSR.

At S6, the base station 500 saves the estimated buffer size of each LCG in the second memory 522.

At S7, the base station 500 transmits, based on the estimated buffer size, uplink grant information (UL-Grant) as grant information to the user equipment 400.

At S8, the base station 500 updates the estimated buffer size in the second memory 522 by subtracting size or the like actually allocated by the UL-Grant from the estimated buffer size.

At S9, the user equipment 400 transmits uplink data based on resource allocation information indicated (identified) by the grant information (UL-Grant) received from the base station 500. Note that timing of S7 and S8 may be reversed.

### <Regarding BSR>

Herein, a Buffer Status Report (BSR) indicated as an example of a buffer status report is described in detail.

For example, the BSR may be any one of a Periodic BSR, a normal Regular BSR and a Padding BSR. In the following, the Periodic BSR and the Regular BSR are specifically described in detail.

### <Periodic BSR>

The user equipment 400 includes a periodic BSR timer (periodicBSR-Timer). A Periodic BSR is transmitted when there is uplink data to be transmitted at a time of expiration of the periodic BSR timer. In addition, the periodicBSR-Timer restarts at timing at which an UL-Grant is allocated and a BSR is allocated. Hence, as long as the UL-Grant allocation is continued, the Periodic BSR is transmitted at a cycle with a length of the periodicBSR-Timer.

### <Regular BSR>

A Regular BSR is transmitted through a processing flow of (1) to (3) below.

(1) The user equipment 400 transmits a Scheduling Request (SR) to the base station 500, when the following A), B) and C) hold.
A) There is data to be transmitted in the buffer 430 of the user equipment 400.
B) A timer called ret×BSR-Timer expires.
C) No UL-Grant has been allocated.
(2) Upon receiving the Scheduling Request, the base station 500 transmits, to the user equipment 400, grant information (UL-Grant) for Regular BSR transmission.
(3) Based on the UL-Grant in (2) described above, the user equipment 400 transmits a Regular BSR.
The ret×BSR-Timer restarts at timing at which an UL-Grant is allocated and a BSR is allocated. Consequently, the SR necessary for Regular BSR transmission is transmitted in a period with a length of the ret×BSR-Timer at the shortest. In addition, the ret×BSR-Timer is used for detecting that no BSR is transmitted for a certain period.

In addition, a length of the periodicBSR-Timer and a length of the ret×BSR-Timer are set in the 3GPP as follows. Since the periodicBSR-Timer is set smaller than the ret×BSR-Timer, a transmission cycle of a Periodic BSR is smaller than the shortest SR transmission-possible period.

The periodicBSR-Timer ranges from 5 [ms] to 2560 [ms].
The ret×BSR-Timer ranges from 320 [ms] to 10240 [ms].

Herein, the timer 440 can be constituted of at least one of the periodicBSR-Timer and the ret×BSR-Timer.

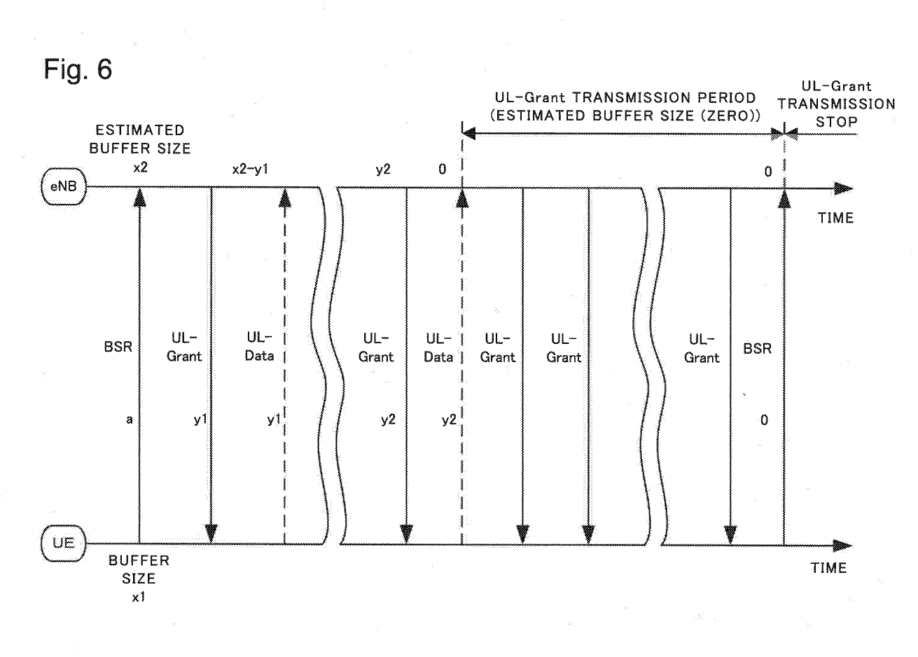

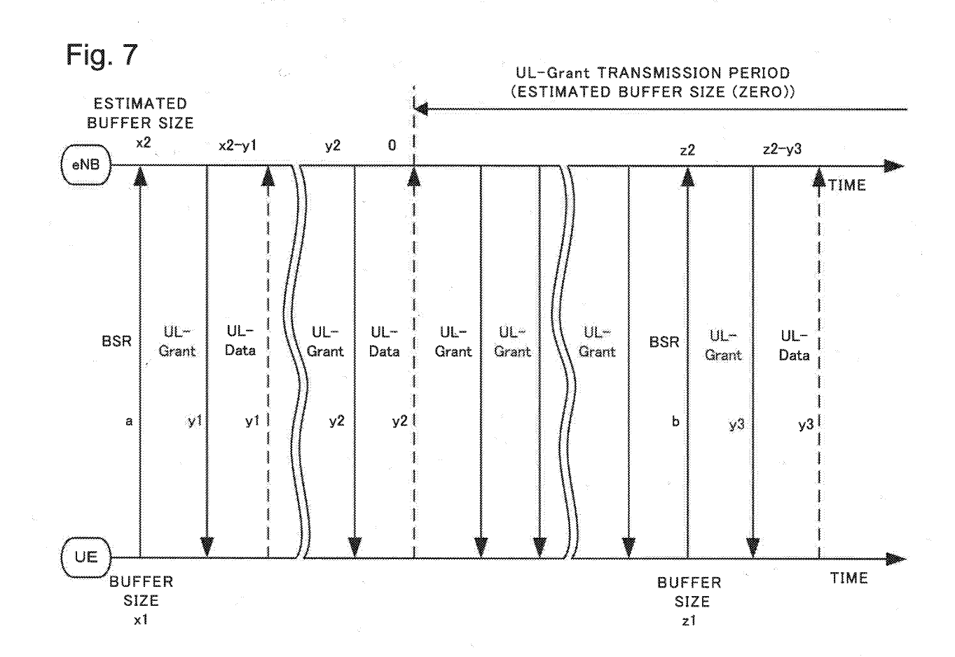

FIGS. 6 and 7 each illustrate an operation according to the second exemplary embodiment.

In FIGS. 6 and 7, transition of an estimated buffer size at the base station 500 (eNB) and timing at which the base station 500 transmits an UL-Grant are illustrated.

In the example in FIG. 6, at a starting point of timing, the buffer 430 of the user equipment 400 (UE) buffers uplink data of “x1” as a data amount (buffer size). Herein, assume that, for example, when the buffer size is “x1”, an index value of a BSR that corresponds to “×1” is “a”.

In FIG. 6, the base station 500 continues UL-Grant allocation (UL-Grant transmission is continued) until the user equipment 400 notifies a buffer size “zero”. When being notified of the buffer size “zero” from the user equipment 400, the base station 500 stops UL-Grant allocation. In this way, by the base station 500 stopping UL-Grant allocation when recognition with respect to an uplink buffer size of the buffer 430 becomes consistent between the base station 500 and the user equipment 400, unnecessary UL-Grant transmission is prevented.

In FIG. 7, the base station 500 continues UL-Grant allocation until the user equipment 400 notifies a buffer size “zero”. When being notified of a buffer size other than “zero” from the user equipment 400, the base station 500 performs UL-Grant allocation corresponding to the buffer size.

### <Operation in Common Relating to FIGS. 6 and. 7>

(1) The user equipment 400 transmits, to the base station 500, a BSR indicating “a” as an index value of the BSR that corresponds to a buffer size “x1”.

(2) Based on the received BSR, the base station 500 estimates that a buffer size of the buffer 430 of the user equipment 400 is “x2”.

(3) When assuming that “y1” is a data size of a resource that can be allocated to the user equipment 400 and can be transmitted, the base station 500 transmits grant information (UL-Grant) indicating that a data size to be allocated to the user equipment 400 is “y1”. In addition, the base station 500 subtracts “y1” from the estimated buffer size and updates the estimated buffer size to “x2-y1”.

(4) Based on the information indicated by the UL-Grant, the user equipment 400 transmits uplink data to the base station 500.

(5) The operation (1) to (4) described above is repeated until a buffer size estimated by the base station 500 becomes “0”. However, (1) and (2) above are operations carried out at timing of transmission and reception of a BSR (Periodic, Regular and Padding BSR). Note that, in FIG. 6, when transmitting such an UL-Grant that a buffer size estimated by the base station 500 is “y2” and a data size to be allocated is “y2”, it is assumed that an estimated buffer size becomes “zero”.

(6) When a buffer size estimated by the base station 500 becomes “zero”, the base station 500 transmits an UL-Grant for a BSR to the user equipment 400 continuously for every subframe or at a constant frequency. Herein, it is assumed that the UL-Grant indicates an allocation size that can be transmitted by a BSR and that is as little as possible. The user equipment 400 transmits a BSR based on the information notified by the UL-Grant.

### <In a Case of FIG. 6>

(7-a) When being notified that a buffer size is “zero” by the BSR from the user equipment 400 during the operation (6) described above, the base station 500 stops UL-Grant allocation. In this case, the base station 500 may determine that an amount of uplink data buffered by the user equipment 400 is zero or substantially zero. The UL-Grant allocation may be stopped based on the above determination.

### <In a Case of FIG. 7>

(7-b) When being notified that a buffer size is “larger than zero” by the BSR from the user equipment 400 during the operation (6) described above, the base station 500 updates the estimated buffer size by a notified value (in a case of FIG. 7, a value “z2”) and subsequently repeats the operation (1) to (7) described above.

As described above, according to the present exemplary embodiment, the base station estimates that a size of an uplink buffer of the user equipment is “zero”, and thereafter the user equipment transmits a buffer status report (BSR) to the base station. Thus, transmission of a grant notification is continued even during a period before a buffer size of the user equipment is notified to the base station. Consequently, even when assuming that recognition inconsistency with respect to a size of an uplink buffer of the user equipment occurs between the base station and the user equipment, a standby time for UL-Grant allocation is eliminated (or shortened). Therefore, retention of uplink data of the user equipment can be suppressed.

In addition, as described above, when the user equipment notifies the base station of a fact that a buffer size of the user equipment is “zero”, the base station stops UL-Grant allocation based on the notification. In other words, the base station is able to stop UL-Grant allocation based on the notification without estimating an uplink buffer size of the user equipment. As a result, unnecessary UL-Grant allocation by the base station can be prevented.

In addition, as described above, it is possible to prevent a case of keeping standby until presence of uplink data to be transmitted in the buffer of the user equipment is recognized (for example, a case of keeping standby for UL data transmission until the ret×BSR-Timer expires). In other words, the base station is able to allocate a resource to the user equipment without a standby time.

### Third Exemplary Embodiment

A third exemplary embodiment is described below.

In the present exemplary embodiment, after a buffer size estimated by the base station 500 becomes “zero” at (6) in the above operation description in FIG. 6, the base station 500 restricts (limits) transmission of an UL-Grant for transmitting a BSR to the user equipment 400 when a condition described below is satisfied. For example, transmission of an UL-Grant may be stopped, and a transmission frequency of an UL-Grant per predetermined time may be limited.

The aforementioned condition is a case in which Discontinuous Transmission (DTX) determination on an UL-Grant for a BSR has been made for a predetermined number of times. In other words, the aforementioned condition is a case in which the user equipment 400 has failed to receive an UL-Grant for a predetermined number of times, a case in which the user equipment 400 has missed an UL-Grant, or the like.

One of conceivable causes of the DTX determination made at the user equipment 400 although the base station 500 has performed a plurality of times of UL-Grant transmission is that the user equipment 400 moves close to a cell end after a buffer size estimated by the base station 500 becomes “zero” and the user equipment 400 is unable to secure electrical power necessary for recognizing an UL-Grant being transmitted from the base station 500. Even when transmission of an UL-Grant is continued continuously in such a case, there is less possibility that the UL-Grant can be processed normally.

As described above, by restricting UL-Grant transmission, unnecessary UL-Grant generation can be prevented.

### Other Exemplary Embodiments

As described above, user equipment (UE) reports an amount of uplink data (UL buffer amount) buffered in an uplink buffer to a base station (eNB) in order to perform data communication between the user equipment and the eNB.

For example, the UL buffer amount is indicated by an index value. A buffer status report (BSR) including the index value is reported from the user equipment to the eNB. In addition, the eNB receives the BSR. An index value of a BSR indicates that an amount of uplink data is in a range between certain values. The eNB estimates, from the index value, a buffer amount actually buffered in a buffer of the UE. The eNB allocates a radio resource to the UE by using an UL-Grant. The eNB subtracts the allocated size from the estimated buffer amount and updates a value of the estimated buffer amount. Thus, there may occur a case in which recognition with respect to an UL buffer amount that the UE actually has and an UL buffer amount that the eNB estimates is inconsistent between the eNB and the UE. For example, there is a possibility that the eNB may regard that no UL buffer is present (zero) at a point in time when the eNB transmits an UL-Grant corresponding to an estimated buffer size. In this case, even when uplink data to be transmitted is actually present in the UL buffer of the UE, there is a possibility that the eNB does not allocate, to the UE, an UL-Grant necessary for transmitting a whole UL buffer amount that the UE has. The reason is that the eNB regards that no UL buffer is present and stops UL-Grant transmission. In other words, there is a possibility that, although uplink data to be transmitted is present in the UL buffer of the UE, a radio resource for the uplink data cannot be allocated until the eNB recognizes the actual presence of the UL buffer of the UE. The inventor has discovered this possibility.

The above-described exemplary embodiment is effective in a situation described below, for example.

When the ret×BSR-Timer of the user equipment expires and thereafter a Regular BSR is transmitted to the base station, the base station recognizes that uplink data to be transmitted is present in the buffer of the UE. However, since a time before the expiration of the ret×BSR-Timer is a time after a lapse of a certain time from a time at which an UL-Grant has been last allocated, a standby time for the transmission of the Regular BSR may be generated. As a result, there is a possibility that allocation by an UL-Grant may be delayed. Specifically, the delay may occur in cases described below.

### (1) New Data Timing Mismatch.

A first case is that new UL data arrives at the buffer of the user equipment immediately after transmission of a BSR by the user equipment.

### (2) Misrecognition.

A second case is that the user equipment fails to receive an UL-Grant transmitted by the base station, and the base station misrecognizes that the user equipment has transmitted UL data although the user equipment has actually failed to transmit the UL data.

### (3) Misunderstanding due to Methods of Calculation by User Equipment and Base Station.

A case is that the base station estimates a buffer size without consideration of a data header, a MAC Control Element and the like in a PDCP layer, a RLC layer or a MAC layer included in UL data, and an uplink buffer size of the user equipment is calculated based on a buffer size in a PDCP or RLC layer.

A wireless communication system to be a subject of each of the above-described exemplary embodiments is applicable to, but not limited to, 3GPP Long Term Evolution (LTE), 3GPP Wideband Code Division Multiple Access (W-CDMA), a Global System for Mobile communications (GSM®), Worldwide interoperability for Microwave Access (WiMAX) and the like.

In addition, the above-described wireless communication system and a wireless communication terminal can be implemented by hardware, software, or a combination thereof. In addition, a method of controlling the above-described communication system can also be implemented by hardware, software, or a combination thereof. Herein, an expression “implemented by software” indicates implementation by a computer reading and executing a program.

A program can be stored using various types of a non-transitory computer readable medium and supplied to a computer. The non-transitory computer readable medium includes various types of a tangible storage medium. Examples of the non-transitory computer readable medium include a magnetic recording medium (for example, a flexible disk, a magnetic tape, and a hard disk drive), a magneto-optical recording medium (for example, a magneto-optical disk), a Compact Disc-Read Only Memory (CD-ROM), a Compact Disc-Recordable (CD-R), a Compact Disc-Rewritable (CD-R/W), a Digital Versatile Disc-ROM (DVD-ROM), a Digital Versatile Disc-Recordable (DVD-R), a Digital Versatile Disc-Rewritable (DVD-R/W), and a semiconductor memory (for example, a Mask ROM, a Programmable ROM (PROM), an Erasable PROM (EPROM), a Flash ROM, and a Random Access Memory (RAM)).

In addition, a program may be supplied to a computer by using various types of a transitory computer readable medium. Examples of the transitory computer readable medium include an electrical signal, an optical signal, and an electromagnetic wave. The transitory computer readable medium can supply a program to a computer via a wired communication path such as an electric wire and an optical fiber, or a wireless communication path.

In addition, each of the above-described exemplary embodiments can be carried out in combination as appropriate. In addition, the present invention is not limited to each of the above-described exemplary embodiments, but can be carried out in various modes.

### (Supplementary Notes)

A part or whole of the exemplary embodiments described above can be described as the following supplementary notes. However, each of the following supplementary notes is merely an example of the present invention, and the present invention is not limited to these cases.

### (Supplementary Note 1)

A communication system including user equipment and a base station, wherein

the user equipment is configured to

buffer uplink data and

transmit, in an uplink, a buffer status report for identifying an amount of the buffered uplink data,

the base station is configured to

transmit, in a downlink, grant information for allocating a radio resource to the user equipment, and

the user equipment

transmits, based on an amount of the buffered uplink data, the buffer status report indicating a request to stop transmission of the grant information.

### (Supplementary Note 2)

A base station configured to be able to communicate with user equipment, the base station including:

a receiver configured to receive, in an uplink, a buffer status report for identifying an amount of uplink data buffered by the user equipment;

a transmitter configured to transmit, in a downlink, grant information for allocating a radio resource for the uplink data; and

a processor that controls the transmitter so as to stop transmission of the grant information when the buffer status report indicates a request to stop transmission of the grant information.

### (Supplementary Note 3)

The base station according to Supplementary note 2, wherein

the base station stops transmission of the grant information, based on the control.

### (Supplementary Note 4)

The base station according to Supplementary note 2 or 3, wherein

the base station is configured to be able to estimate a buffer size of the user equipment, based on the buffer status report.

### (Supplementary Note 5)

The base station according to Supplementary note 4, wherein, when the estimated buffer size of the user equipment is zero and the user equipment fails, for a predetermined number of times, to receive the grant information transmitted after the estimation, transmission of the grant information is limited.

### (Supplementary Note 6)

The base station according to any one of Supplementary notes 2 to 5, wherein,

when the buffer status report indicates a request to stop transmission of the grant information,

the base station determines that an amount of uplink data buffered by the user equipment is substantially zero.

### (Supplementary Note 7)

The base station according to any one of Supplementary notes 2 to 6, wherein,

when the buffer status report does not indicate a request to stop transmission of the grant information,

the base station does not stop transmission of the grant information.

### (Supplementary Note 8)

User equipment including:

a buffer configured to buffer uplink data;

a transmitter configured to transmit, in an uplink, a buffer status report for identifying an amount of uplink data buffered in the buffer;

a receiver configured to receive, in a downlink, grant information for allocating a radio resource to the user equipment; and

a processor configured to be able to control the transmitter, based on an amount of uplink data buffered in the buffer, in a way such that the buffer status report includes information indicating a request to stop transmission of the grant information.

### (Supplementary Note 9)

A communication method of user equipment, including:

buffering uplink data;

transmitting, in an uplink, a buffer status report for identifying an amount of the buffered uplink data;

receiving, in a downlink, grant information for allocating a radio resource to the user equipment; and

controlling the transmitter, based on an amount of the buffered uplink data, in a way such that the buffer status report includes information indicating a request to stop transmission of the grant information.

### (Supplementary Note 10)

A program for causing a computer to execute a communication method of user equipment, the program causing the computer to execute:

a process of buffering uplink data;

a process of transmitting, in an uplink, a buffer status report for identifying an amount of the buffered uplink data;

a process of receiving, in a downlink, grant information for allocating a radio resource to the user equipment; and

a process of controlling the transmitter, based on an amount of the buffered uplink data, in a way such that the buffer status report includes information indicating a request to stop transmission of the grant information.

### (Supplementary Note 11)

A communication system including user equipment and a base station, wherein

the user equipment is configured to

buffer uplink data and

transmit, in an uplink, a buffer status report for identifying an amount of the buffered uplink data,

the base station is configured to

transmit, in a downlink, grant information for allocating a radio resource to the user equipment,

the user equipment

transmits, based on an amount of the buffered uplink data, the buffer status report for stopping of transmission of the grant information by the base station, and

the base station

receives the buffer status report and

stops transmission of the grant information, based on the received buffer status report.

### (Supplementary Note 12)

The communication system according to Supplementary note 11, wherein

the base station is configured to be able to estimate a buffer size of the user equipment, based on the buffer status report.

### (Supplementary Note 13)

The communication system according to Supplementary note 12, wherein,

when the estimated buffer size of the user equipment is zero and the user equipment fails, for a predetermined number of times, to receive the grant information transmitted after the estimation,

transmission of the grant information is limited.

### (Supplementary Note 14)

The communication system according to any one of Supplementary notes 11 to 13, wherein,

when the buffer status report does not indicate a request to stop transmission of the grant information,

the base station does not stop transmission of the grant information.

### (Supplementary Note 15)

The communication system according to Supplementary note 12, wherein,

when the estimated buffer size is zero and the buffer status report received after the estimation does not indicate stopping of transmission of the grant information by the base station,

transmission of the grant information is continued.

### (Supplementary Note 16)

A base station configured to be able to communicate with user equipment, the base station including:

a receiver configured to receive, in an uplink, a buffer status report for identifying an amount of uplink data buffered by the user equipment;

a transmitter configured to transmit, in a downlink, grant information for allocating a radio resource for the uplink data; and

a processor that controls the transmitter so as to stop transmission of the grant information when the buffer status report indicates stopping of transmission of the grant information by the base station.

### (Supplementary Note 17)

User equipment including:

a buffer configured to buffer uplink data;

a transmitter configured to transmit, in an uplink, a buffer status report for identifying an amount of uplink data buffered in the buffer;

a receiver configured to receive, in a downlink, grant information for allocating a radio resource to the user equipment; and

a processor configured to be able to control the transmitter, based on an amount of uplink data buffered in the buffer, in a way such that the buffer status report includes information indicating stopping of transmission of the grant information.

### (Supplementary Note 18)

A communication method of a base station, including:

receiving, in an uplink, a buffer status report for identifying an amount of uplink data buffered by user equipment;

transmitting, in a downlink, grant information for allocating a radio resource for the uplink data; and

stopping transmission of the grant information when the buffer status report indicates stopping of transmission of the grant information by the base station.

### (Supplementary Note 19)

A program for causing a computer to execute a communication method of a base station, the program causing the computer to execute:

a process of receiving, in an uplink, a buffer status report for identifying an amount of uplink data buffered by user equipment;

a process of transmitting, in a downlink, grant information for allocating a radio resource for the uplink data; and

a process of stopping transmission of the grant information when the buffer status report indicates stopping of transmission of the grant information by the base station.

### (Supplementary Note 20)

A recording medium that stores a program for causing a computer to execute a communication method of a base station, the program for causing the computer to execute:

receiving, in an uplink, a buffer status report for identifying an amount of uplink data buffered by user equipment;

transmitting, in a downlink, grant information for allocating a radio resource for the uplink data; and

stopping transmission of the grant information when the buffer status report indicates stopping of transmission of the grant information by the base station.

This application is based upon and claims the benefit of priority from Japanese Patent Application No. 2014-179456, filed on Sep. 3, 2014, the disclosure of which is incorporated herein in its entirety.

### REFERENCE SIGNS LIST

1 Communication system
2 User equipment
3 Base station
21 Buffer
22 Transmitter
23 Receiver
24 Processor
31 Receiver
32 Transmitter
33 Processor
400 User equipment
410 First physical layer control unit
420 MAC layer unit
421 Data transmission unit
422 First memory
430 Buffer
431 Logical channel
440 Timer
500 Base station
510 Second physical layer control unit
520 MAC layer unit
521 Scheduler control unit
522 Second memory

What is claimed is:

1. A communication system comprising:
user equipment; and
a base station,
wherein the user equipment is configured to
buffer uplink data and
transmit, in an uplink, a buffer status report for identifying an amount of the uplink data buffered,
wherein the base station is configured to
transmit, in a downlink, grant information for allocating a radio resource to the user equipment,
wherein the user equipment
transmits, based on the amount of the buffered uplink data, the buffer status report for stopping of transmission of the grant information by the base station, and
wherein the base station
receives the buffer status report and
stops the transmission of the grant information, based on the received buffer status report.

2. A base station configured to communicate with user equipment, the base station comprising:
a receiver configured to receive, in an uplink, a buffer status report for identifying an amount of uplink data buffered by the user equipment;
a transmitter configured to transmit, in a downlink, grant information for allocating a radio resource for the uplink data; and
a processor configured to control the transmitter to stop transmission of the grant information when the buffer status report indicates stopping transmission of the grant information by the base station.

3. The base station according to claim 2,
wherein the base station is configured to estimate a buffer size of the user equipment based on the buffer status report.

4. The base station according to claim 3,
wherein, when the buffer size estimated is zero and the user equipment fails, for a predetermined number of times, to receive the grant information transmitted after the estimation,
the transmission of the grant information is limited.

5. The base station according to claim 2,
wherein, when the buffer status report indicates stopping transmission of the grant information by the base station,
the base station determines that an amount of uplink data buffered by the user equipment is substantially zero.

6. The base station according to claim 2,
wherein, when the buffer status report does not indicate stopping transmission of the grant information,
the base station does not stop the transmission of the grant information.

7. The base station according to claim 3,
wherein, when the estimated buffer size is zero and the buffer status report received after the estimation does not indicate stopping of transmission of the grant information by the base station,
transmission of the grant information is continued.

8. User equipment comprising:
a buffer configured to buffer uplink data;
a transmitter configured to transmit, in an uplink, a buffer status report for identifying an amount of uplink data buffered in the buffer;
a receiver configured to receive, in a downlink, grant information for allocating a radio resource to the user equipment; and
a processor configured to control the transmitter, based on an amount of uplink data buffered in the buffer, in a way such that the buffer status report includes information indicating stopping of transmission of the grant information.

9. A communication method for a base station, the method comprising:
receiving, in an uplink, a buffer status report for identifying an amount of uplink data buffered by user equipment;
transmitting, in a downlink, grant information for allocating a radio resource for the uplink data; and
stopping transmission of the grant information when the buffer status report indicates stopping of transmission of the grant information by the base station.

10. A non-transitory computer recording medium that stores a program for causing a computer to execute a communication method for a base station, the method comprising:
receiving, in an uplink, a buffer status report for identifying an amount of uplink data buffered by user equipment;
transmitting, in a downlink, grant information for allocating a radio resource for the uplink data; and
stopping transmission of the grant information when the buffer status report indicates stopping of transmission of the grant information by the base station.
